(19) United States
(12) Patent Application Publication
(10) Pub. No.: US 2026/0329022 A1
(43) Pub. Date: Oct. 22, 2026

(54) INFORMATION DEVICE, METHOD FOR MANUFACTURING INFORMATION DEVICE, AND OPTICAL CONNECTION MODULE

(71) Applicant: SUMITOMO ELECTRIC INDUSTRIES, LTD., Osaka (JP)

(72) Inventors: Yasunori ASANO, Osaka (JP); Takeshi INOUE, Osaka (JP); Masaki SUZUKI, Osaka (JP); Shun ENDO, Osaka (JP)

(73) Assignee: SUMITOMO ELECTRIC INDUSTRIES, LTD., Osaka (JP)

(21) Appl. No.: 19/649,472

(22) Filed: Apr. 16, 2026

(30) Foreign Application Priority Data
Apr. 21, 2025 (JP) 2025-069481

(51) Int. Cl. G02B 6/42

(52) U.S. Cl. CPC G02B 6/4202; G02B 6/423; G02B 6/4243; G02B 6/4246; G02B 6/4262; G02B 6/428; G02B 6/4298

(57) ABSTRACT

An information device includes a first member including a first surface, a second member connected to the first member, a first terminal disposed in the first member, a second terminal disposed in the second member, and an optical fiber optically connecting the first terminal to the second terminal. The optical fiber is arranged along the first surface in the first member. The optical fiber includes at least one curved portion that is bent at a corner of the first member.

### CROSS REFERENCE TO RELATED APPLICATION

This application claims priority based on Japanese Patent Application No. 2025-069481, filed on Apr. 21, 2025, and the entire contents of the Japanese patent application are incorporated herein by reference.

### TECHNICAL FIELD

The present disclosure relates to an information device, a method for manufacturing an information device, and an optical connection module.

### BACKGROUND

JP2011-119698A discloses an openable electronic device (for example, a laptop computer) including a first housing and a second housing. In this electronic device, a first connector is disposed in the first housing, and a second connector is disposed in the second housing. The first connector and the second connector are electrically connected to each other by a cable. JPH06-131077A and JP2001-154760A disclose other openable electronic devices.

### SUMMARY

An information device according to the present disclosure includes a first member including a first surface, a second member connected to the first member, a first terminal disposed in the first member, a second terminal disposed in the second member, and an optical fiber optically connecting the first terminal to the second terminal. The optical fiber is arranged along the first surface in the first member. The optical fiber has at least one curved portion that is bent at a corner of the first member.

### BRIEF DESCRIPTION OF THE DRAWINGS

FIG. 1 is a perspective view showing an example of an information device according to an embodiment.

FIG. 2 is a view showing an optical connection module used in the information device shown in FIG. 1.

FIG. 3 is a perspective view showing a state in which an optical fiber passes through a hinge in the optical connection module shown in FIG. 2.

FIG. 4 is a perspective view showing a part of an arrangement (routing) of the optical connection module in a device body (housing portion) of the information device shown in FIG. 1.

FIG. 5 is a perspective view showing an example of an accommodating member that accommodates a curved portion of the optical fiber.

FIG. 6 is a perspective view for explaining a method for attaching the accommodating member shown in FIG. 5.

FIG. 7 is a perspective view showing a modification of the accommodating member that accommodates the curved portion of the optical fiber.

FIG. 8 is a perspective view showing another modification of the accommodating member that accommodates the curved portion of the optical fiber.

### DETAILED DESCRIPTION

In information devices such as laptop computers, signal transmission capacity inside the device is increasing due to reasons such as improvement in performance of built-in electronic devices (for example, cameras). Therefore, it is considered to use an optical fiber instead of or together with a conventional electric cable. However, the optical fiber is more easily damaged than the electric cable. Thus, there is a need for an information device capable of preventing damage when arranging an optical fiber in a housing or the like, a manufacturing method thereof, and an optical connection module.

An object of the present disclosure is to provide an information device capable of preventing damage to an optical fiber when arranging the optical fiber in the information device, a method for manufacturing the information device, and an optical connection module.

Contents of embodiments of the present disclosure will be listed and described.
(1) An information device according to an embodiment includes a first member including a first surface, a second member connected to the first member, a first terminal disposed in the first member, a second terminal disposed in the second member, and an optical fiber optically connecting the first terminal to the second terminal. The optical fiber is arranged along the first surface in the first member. The optical fiber has at least one curved portion that is bent at a corner of the first member.

In the information device of the above (1), the optical fiber optically connecting the first terminal and the second terminal is provided. In this case, signal transmission capacity can be increased in the information device. Further, in this information device, the optical fiber is arranged in the first member such that the optical fiber includes at least one curved portion that is bent at the corner of the first member. In this case, the optical fiber can be arranged avoiding a region where a large member (for example, a display) is disposed in the first member, and damage to the optical fiber can be prevented. Furthermore, in this information device, since the optical fiber is used for signal transmission, noise to the signal can be reduced.
(2) The information device of the above (1) may further include an accommodating member that accommodates the curved portion of the optical fiber. This accommodating member may be attached to the corner of the first member. In this case, the curved portion of the optical fiber is protected by the accommodating member. Therefore, damage to the optical fiber, particularly damage to the curved portion, can be prevented.
(3) In the information device of the above (2), the accommodating member may be integrally molded with the curved portion of the optical fiber. In this case, movement of the optical fiber with respect to the accommodating member is restricted. Therefore, damage to the optical fiber accompanying the movement can be prevented. Further, damage to the curved portion of the optical fiber can be reliably prevented.
(4) In the information device of the above (2), the accommodating member may include a curved groove corresponding to the curved portion of the optical fiber, and the curved portion may be fitted into this curved groove. In this case, the curved portion of the optical fiber is securely fixed by the accommodating member. Therefore, damage accompanying movement of the optical fiber can be prevented. Further, damage to the curved portion of the optical fiber can be reliably prevented.
(5) In the information device of any one of the above (2) to (4), the accommodating member may include an attachment surface parallel to the first surface. In this case, when attaching the accommodating member to the first member, the accommodating member can be attached with high accuracy by sucking the attachment surface using a suction jig. Therefore, damage to the optical fiber can be reduced compared to a case where the accommodating member is disposed with displacement and thus the optical fiber is damaged.
(6) In the information device of any one of the above (2) to (5), the curved portion may be a portion where the optical fiber is bent when no external force is applied to the optical fiber. In this case, damage at the curved portion where the optical fiber is bent can be prevented. Further, when the curved portion where the optical fiber is bent when no external force is applied to the optical fiber is accommodated in the accommodating member, damage to the optical fiber is more reliably prevented.
(7) In the information device of any one of the above (1) to (6), the optical fiber may be bent at two or more locations in the first member, and the curved portion may include a first curved portion bent at a first corner of the first member and a second curved portion bent at a second corner of the first member. In the first curved portion and the second curved portion, the optical fiber may be bent to have an angle of 85 degrees to 95 degrees. In this case, the optical fiber can be efficiently arranged along a frame of the first member avoiding a region where a large member is disposed. Therefore, the information device can be reduced in size or thickness while preventing damage to the optical fiber.
(8) In the information device of any one of the above (1) to (7), each of the first terminal and the second terminal may include a board, an electrical connector disposed on the board, and a photoelectric conversion element electrically connected to the electrical connector and optically connected to the optical fiber. In this case, photoelectric conversion can be performed in each of the first terminal and the second terminal.
(9) The information device of any one of the above (1) to (8) may further include a hinge that connects the first member to the second member in an openable and closable manner. The optical fiber may pass through this hinge between the first terminal and the second terminal. In this case, in the openable and closable information device, transmission capacity between the first member and the second member can be significantly increased while reducing the size or thickness of the device.
(10) As another aspect, the present disclosure relates to a method for manufacturing an information device. This method for manufacturing an information device includes preparing an optical connection module including a first terminal, a second terminal, and an optical fiber optically connecting the first terminal to the second terminal, preparing a device body including a first member including a first surface and a second member connected to the first member, attaching the first terminal to the first member, attaching the second terminal to the second member, and arranging the optical fiber along the first surface in the first member. In this method for manufacturing an information device, when arranging the optical fiber, at least one curved portion where the optical fiber is bent at a corner of the first member is provided.

In the method for manufacturing an information device of the above (10), the optical fiber optically connecting the first terminal and the second terminal is provided. In this case, an information device with increased signal transmission capacity can be obtained. Further, in this method for manufacturing an information device, the optical fiber is arranged in the first member such that the optical fiber includes at least one curved portion that is bent at the corner of the first member. In this case, the optical fiber can be arranged avoiding a region where a large member (for example, a display) is disposed in the first member, and damage to the optical fiber can be prevented during manufacturing.
(11) In the method for manufacturing an information device of the above (10), the optical connection module or the first member may further include an accommodating member configured to accommodate the curved portion of the optical fiber. In this manufacturing method, when arranging the optical fiber, the accommodating member of the optical connection module in which the curved portion is accommodated may be attached to the corner of the first member, or the optical fiber may be attached to the accommodating member provided at the corner of the first member to form the curved portion. In any case, it is possible to prevent the optical fiber from being damaged when attaching the optical fiber.
(12) In the method for manufacturing an information device of the above (11), the accommodating member may include an attachment surface facing the curved portion of the optical fiber, and when attaching the accommodating member, the accommodating member may be attached to the corner of the first member by sucking the attachment surface of the accommodating member using a suction jig. In this case, when attaching the accommodating member to the first member, the accommodating member can be attached with high accuracy by sucking the attachment surface using the suction jig. Further, work of attaching the accommodating member to the first member can be automated to improve assembly efficiency, or a defect rate during assembly can be reduced.
(13) In the method for manufacturing an information device of the above (11) or (12), when arranging the optical fiber, the accommodating member accommodating the curved portion formed by bending the optical fiber in advance may be attached to the corner of the first member. In this case, cracking when providing the curved portion in the optical fiber can be prevented.
(14) In the method for manufacturing an information device of the above (10), the first member may further include an accommodating member configured to accommodate the curved portion of the optical fiber. In this manufacturing method, when arranging the optical fiber, the curved portion formed by bending the optical fiber in advance may be attached to the accommodating member provided at the corner of the first member. In this case, cracking of the curved portion of the optical fiber can be more reliably prevented.
(15) In the method for manufacturing an information device of any one of the above (10) to (14), the first member and the second member may be connected in an openable and closable manner by a hinge, and the optical fiber may pass through the hinge between the first terminal and the second terminal. In this case, it is possible to obtain an openable and closable information device in which transmission capacity between the first member and the second member is significantly increased while reducing the size or thickness of the device.
(16) As still another aspect, the present disclosure relates to an optical connection module. The optical connection module includes a first terminal, a second terminal, and an optical fiber optically connecting the first terminal to the second terminal. In this optical connection module, an accommodating member configured to accommodate a curved portion where the optical fiber is bent is provided, or a curved portion where the optical fiber is bent when no external force is applied to the optical fiber is formed in the optical fiber. By using such an optical connection module, an information device in which the curved portion is provided at the corner of the first member can be easily manufactured.

### DETAILS OF EMBODIMENTS OF THE PRESENT DISCLOSURE

Specific examples of an information device, a method for manufacturing an information device, and an optical connection module according to embodiments of the present disclosure will be described below with reference to the drawings. The present disclosure is not limited to the following examples, but is defined by the scope of the claims, and is intended to include all modifications within the scope equivalent to the scope of the claims. In the description of the drawings, the same or corresponding elements are denoted by the same reference numerals, and redundant description will be omitted as appropriate. The drawings may be partially simplified, omitted, or exaggerated for ease of understanding, and dimensional ratios and the like are not limited to those described in the drawings.

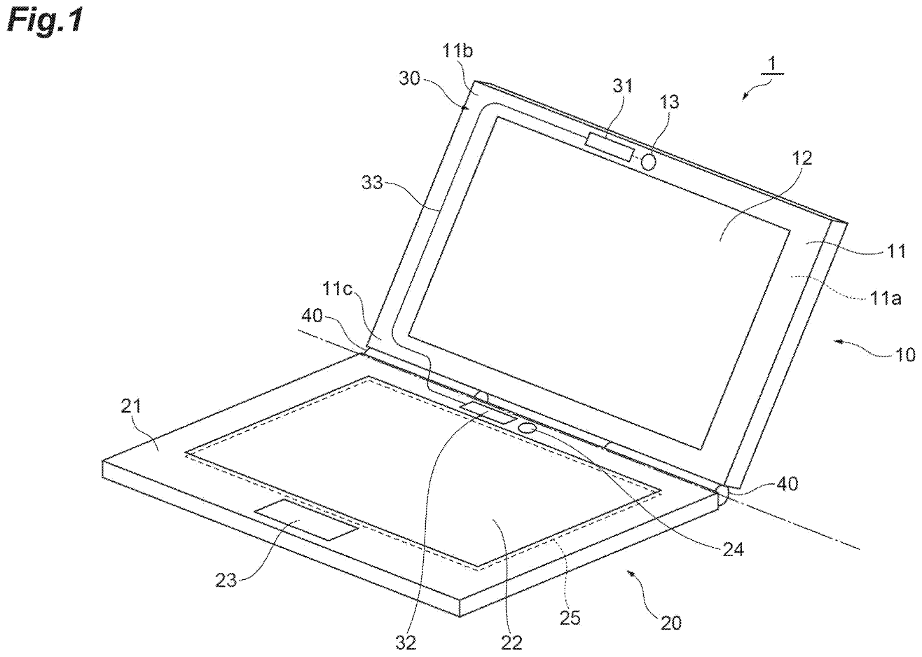

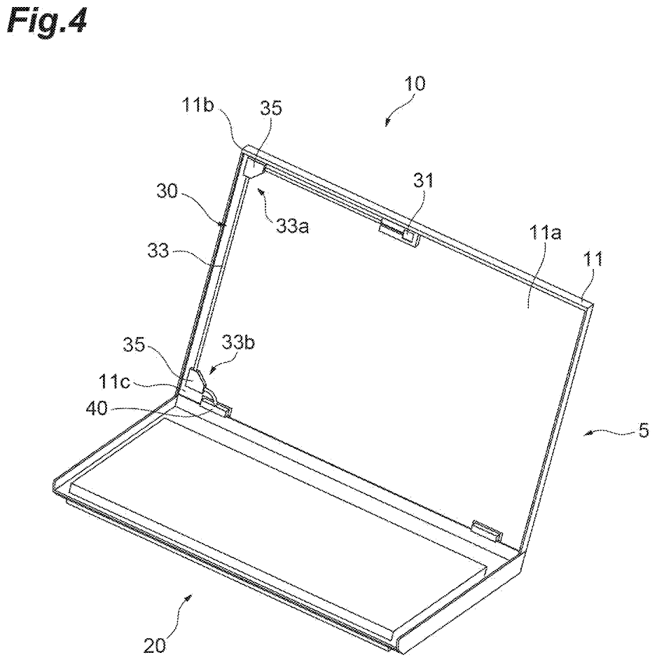

FIG. 1 is a perspective view showing an example of an information device according to an embodiment. As shown in FIG. 1, an information device 1 is, for example, a laptop computer, and includes a first member 10 and a second member 20. The first member 10 is a monitor portion, and the second member 20 is a body portion. The first member 10 is connected to the second member 20 in an openable and closable manner using a hinge 40. The first member 10 has, for example, a housing 11, a display 12, and a camera 13. The housing 11 has a rectangular inner surface 11a (first surface) (see also FIG. 4), and the display 12 and the camera 13 are attached to the housing 11. The display 12 is, for example, a liquid crystal display, and the camera 13 is a Web camera. The display 12 and the camera 13 are driven by receiving electric signals.

The second member 20 has a housing 21, a keyboard 22, a touch pad 23, a power button 24, and a motherboard 25. Each of the keyboard 22, the touch pad 23, and the power button 24 is electrically connected to the motherboard 25. The keyboard 22, the touch pad 23, and the power button 24 are parts operated by a user of the information device 1. By operating each of the keyboard 22, the touch pad 23, and the power button 24, signals are output from the motherboard 25 to respective parts of the information device 1, and the respective parts of the information device 1 function.

The information device 1 further includes an optical connection module 30. The optical connection module 30 has a first terminal 31, a second terminal 32, and an optical fiber 33. The optical fiber 33 can be regarded as an example of the “optical fiber” in the present application. A plurality of components constituting the information device 1 are electrically connected to each other. The plurality of components constituting the information device 1 operate by receiving electric signals. On the other hand, the optical connection module 30 has the optical fiber 33 and transmits optical signals through the optical fiber 33. The first terminal 31 is connected to a first end of the optical fiber 33, and the second terminal 32 is connected to a second end of the optical fiber 33. In other words, the first terminal 31 is optically connected to the second terminal 32 by the optical fiber 33. The first terminal 31 is disposed in the first member 10, and the second terminal 32 is disposed in the second member 20.

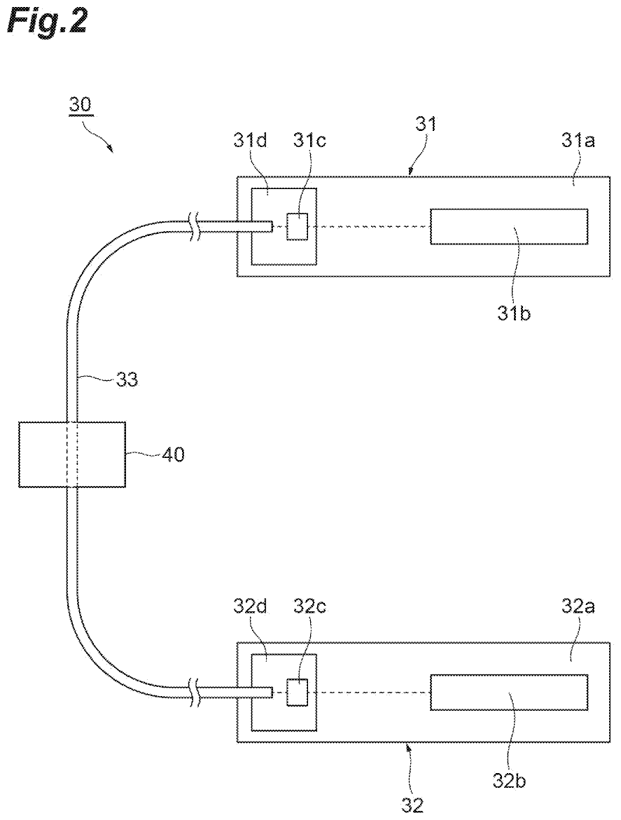

FIG. 2 is a view showing the optical connection module used in the information device 1. As shown in FIGS. 1 and 2, the first terminal 31 has a board 31a, an electrical connector 31b disposed on the board 31a, a photoelectric conversion element 31c electrically connected to the electrical connector 31b and optically connected to the optical fiber 33, and a lens unit 31d including a lens that condenses light from the photoelectric conversion element 31c to the optical fiber 33. The electrical connector 31b is electrically connected to the camera 13. For example, the camera 13 outputs image signals as electric signals to the electrical connector 31b. The type of the electrical connector 31b is not particularly limited.

The photoelectric conversion element 31c converts electric signals into optical signals. The photoelectric conversion element 31c is, as an example, a Vertical Cavity Surface Emitting Laser (VCSEL) which is a type of semiconductor laser diode. The photoelectric conversion element 31c converts, for example, image signals as electric signals input from the camera 13 via the electrical connector 31b into optical signals. The photoelectric conversion element 31c outputs such optical signals to the lens of the lens unit 31d, and the lens condenses the optical signals onto the optical fiber 33.

The optical fiber 33 has a core and a cladding covering the core. The optical fiber 33 is covered with a coating. For example, the optical fiber 33 is a coated optical fiber (including a core, a cladding, and a coating) having an outer diameter of 250 μm. The coated optical fiber is, for example, a multi-mode fiber. The core and the cladding are made of, for example, glass. The core and the cladding may be made of plastic. The type and material of the coated optical fiber are not particularly limited. The optical fiber 33 may further have a coating around the coated optical fiber having an outer diameter of 250 μm. Further, the optical fiber 33 may have a coated optical fiber and a metal wire (for example, made of copper), and the periphery of the coated optical fiber and the metal wire may be covered with a coating. The optical connection module 30 may have one or two or more optical fibers 33. The number of the optical fibers 33 is not particularly limited. The optical fiber 33 extends from the first terminal 31, passes through the hinge 40, and extends to the second terminal 32. The optical fiber 33 transmits the optical signals from the photoelectric conversion element 31c of the first terminal 31 to the second terminal 32. When the optical fiber 33 has the coated optical fiber and the metal wire (for example, made of copper), the coated optical fiber is connected to the lens units 31d and 32d, and the metal wire may be connected to a portion other than the lens unit 31d of the board 31a and a portion other than the lens unit 32d of the board 32a. Further, when the optical fiber 33 has the coated optical fiber and the metal wire, the coated optical fiber is connected to the lens units 31d and 32d, and the metal wire may be connected to boards other than the boards 31a and 32a.

The second terminal 32 has a configuration similar to that of the first terminal 31. The second terminal 32 has a board 32a, an electrical connector 32b disposed on the board 32a, a photoelectric conversion element 32c electrically connected to the electrical connector 32b and optically connected to the optical fiber 33, and a lens unit 32d including a lens that condenses light from the photoelectric conversion element 32c to the optical fiber 33. The second terminal 32 may have a configuration different from that of the first terminal 31. The electrical connector 32b is electrically connected to the motherboard 25. For example, electric signals are output from the electrical connector 32b to the motherboard 25.

The photoelectric conversion element 32c converts optical signals into electric signals. The photoelectric conversion element 32c is, as an example, a photodiode (PD). The photoelectric conversion element 32c converts, for example, optical signals from the lens of the lens unit 32d into electric signals. The photoelectric conversion element 32c converts, for example, the image signals as the above-described optical signals transmitted from the first terminal 31 through the optical fiber 33 into electric signals. The electric signals are output from the photoelectric conversion element 32c to the motherboard 25 via the electrical connector 32b, and is processed by a chipset mounted on the motherboard 25.

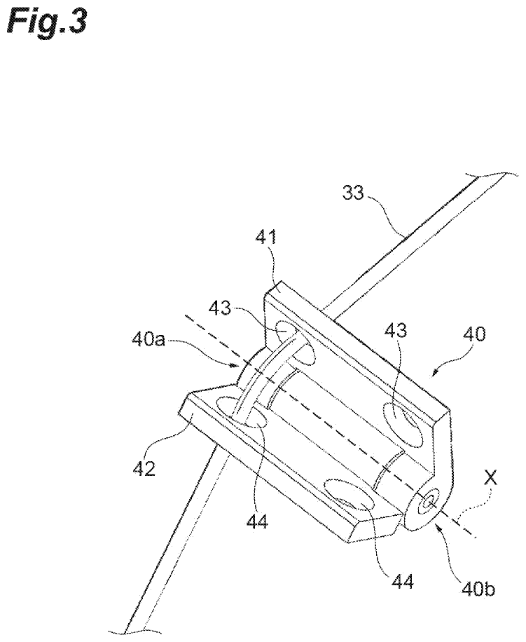

In such an optical connection module 30, the optical fiber 33 is configured to pass through the hinge 40. FIG. 3 is a perspective view showing a state in which the optical fiber 33 passes through the hinge 40. As shown in FIG. 3, the hinge 40 has a first component 41 and a second component 42. The second component 42 is attached to the first component 41 so as to be rotatable about a hinge axis X with respect to the first component 41. The first component 41 is, for example, a metal plate-like member, and is provided with at least one through hole 43. The through hole 43 penetrates the plate-like member. In the example shown in FIG. 3, for example, two through holes 43 are provided. The second component 42 is, for example, a metal plate-like member, and is provided with at least one through hole 44. The through hole 44 penetrates the plate-like member. In the example shown in FIG. 3, for example, two through holes 44 are provided.

The optical fiber 33 is passed through, for example, the through hole 43 and the through hole 44 located at a first end 40a of the hinge 40 in a direction in which the hinge axis X extends. The through hole 43 and the through hole 44 through which the optical fiber 33 is passed are arranged so as to face each other when the first component 41 and the second component 42 are closed. The optical fiber 33 may be passed through the through hole 43 located at the first end 40a of the hinge 40 and the through hole 44 located at a second end 40b. Further, the optical fiber 33 may be passed through the through hole 43 located at the second end 40b of the hinge 40 and the through hole 44 located at the first end 40a. The hinge 40 may be a hinge of another form.

Here, an arrangement (routing) of the optical fiber 33 in the information device 1 will be described with reference to FIGS. 1 and 4. As shown in FIGS. 1 and 4, in the information device 1, the optical fiber 33 of the optical connection module 30 is formed to bend at corners 11b and 11c of the housing 11 of the first member 10. That is, the optical fiber 33 is bent at two curved portions 33a and 33b in the first member 10. A bending angle at the curved portions 33a and 33b of the optical fiber 33 may be, for example, between 85 degrees and 95 degrees, and is 90 degrees as an example. Thereby, L-shaped wiring can be formed in the housing 11.

By bending the optical fiber 33 at the corners 11b and 11c, the optical fiber 33 can be arranged along an outer edge of the housing 11. With this arrangement, the optical fiber 33 can be disposed so as to bypass the display 12. Therefore, it is possible to prevent the optical fiber 33 from being contacted and damaged when arranging the display 12. Further, since the optical fiber 33 is thinner than the electric cable, an arrangement ratio of the display 12 to the housing 11 can be increased. Thereby, the information device 1 can be reduced in size or thickness, or the size of the display 12 can be increased.

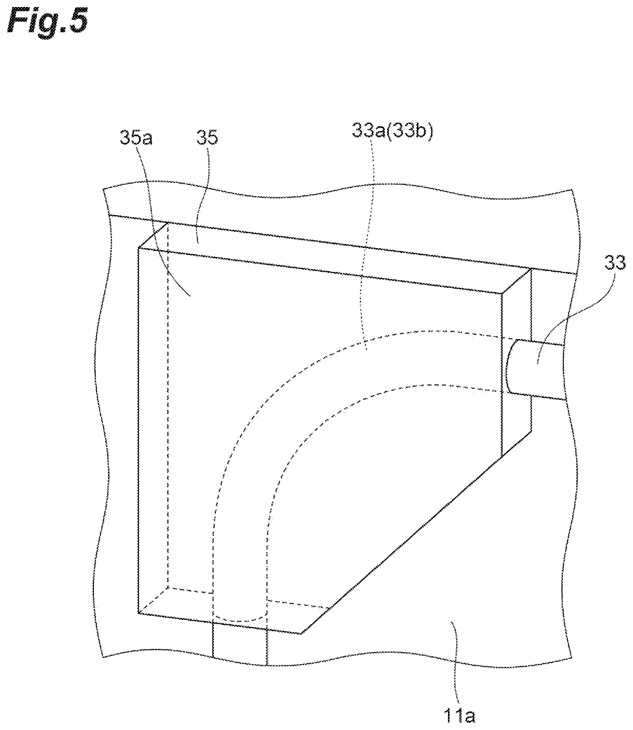

Each of the curved portions 33a and 33b of the optical fiber 33 is accommodated in an accommodating member 35. FIG. 5 is a perspective view showing an example of the accommodating member that accommodates each of the curved portions 33a and 33b of the optical fiber 33. In the example shown in FIG. 5, the accommodating member 35 is produced by insert molding. Such an accommodating member 35 can be obtained, for example, by placing each of the curved portions 33a and 33b of the optical fiber 33 in a mold and performing resin molding. Thereby, the optical fiber 33 (curved portions 33a and 33b) and the accommodating members 35 are integrated into one unit. The optical fiber 33 used for such molding may be one that has been bent to a predetermined angle while applying heat and cooled so that the curved portions 33a and 33b are curved in advance (before molding). Further, the accommodating member 35 including a through hole through which the optical fiber 33 passes may be formed first, and the optical fiber 33 may be passed through the curved through hole (in this case, the optical fiber 33 that is not curved in advance is preferable) to obtain the accommodating member 35 shown in FIG. 5.

Next, a method for manufacturing the information device 1 using the optical connection module 30 will be described. This manufacturing method includes a step of preparing the optical connection module 30, a step of preparing a device body 5 including the first member 10 including the inner surface 11a and the second member 20 connected to the first member 10, a step of attaching the first terminal 31 to the first member 10, a step of attaching the second terminal 32 to the second member 20, and a step of arranging the optical fiber 33 along the inner surface 11a in the first member 10. In this manufacturing method, when arranging (routing) the optical fiber 33 in the first member 10 or the like, at least one (two in the example of the figure) curved portion 33a, 33b where the optical fiber 33 is bent at the corner 11b, 11c of the first member 10 (housing 11) is provided.

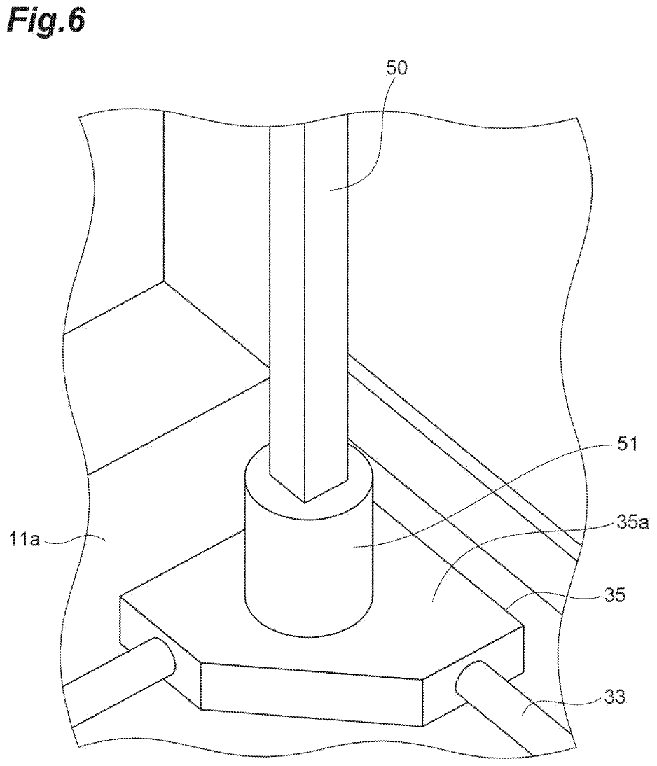

In this manufacturing method, when attaching the optical fiber 33 to the housing 11, a surface 35a (attachment surface) of the accommodating member 35 in which each of the curved portions 33a and 33b of the optical fiber 33 is accommodated is attached by being sucked by a suction portion 51 of a suction jig 50 as shown in FIG. 6. The surface 35a of the accommodating member 35 is a plane parallel to the inner surface 11a of the housing 11, and faces the curved portion 33a or 33b. By sucking and attaching the accommodating member 35 in this manner, the accommodating member 35 (that is, the curved portion 33a or 33b of the optical fiber 33) can be attached to each predetermined position of the corner 11b and 11c of the housing 11 with high accuracy. The accommodating member 35 can be fixed to the inner surface 11a of the housing 11 with an adhesive. Alternatively, a fitting structure (for example, a fitting protrusion or the like) may be provided on a back surface of the accommodating member 35, and a fitting structure (for example, a hole into which the fitting protrusion fits) may be provided in the housing 11, and the accommodating member 35 may be fixed to the housing 11 by fitting them together. Instead of the suction type, the accommodating member 35 may be attached to the housing 11 such that both side surfaces of the accommodating member 35 are sandwiched by claw members.

As shown in FIG. 4, the first terminal 31 is attached near the corner 11b. Since the curved portion 33a of the optical fiber 33 is fixed at this corner 11b, a load applied to the first terminal 31 to which one end of the optical fiber 33 is fixed is reduced. Therefore, even if vibration or the like is applied to the optical fiber 33, vibration applied to the first terminal 31 is reduced. Therefore, in the information device 1, a defect such as detachment of one end of the optical fiber 33 fixed to the first terminal 31 is prevented by the accommodating member 35 attached to the corner 11b.

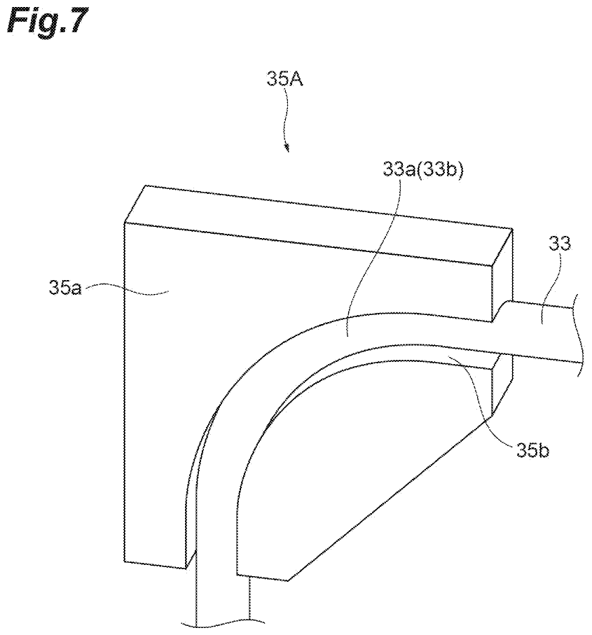

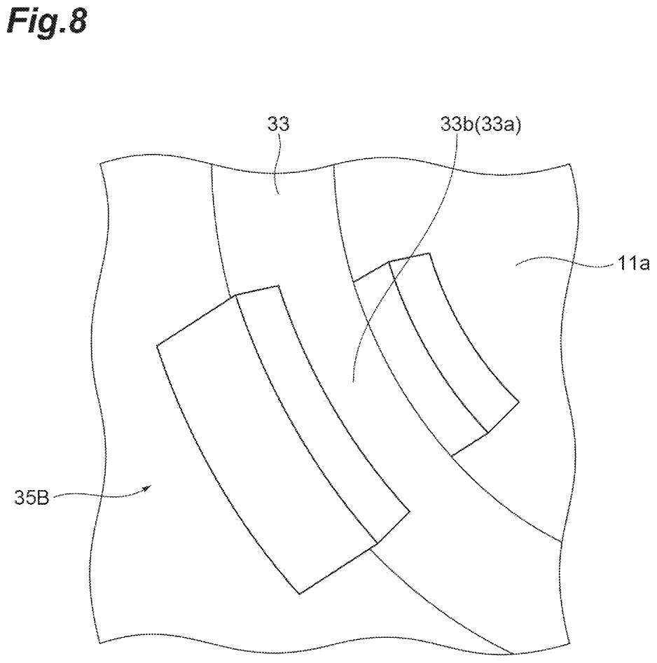

Here, modifications of the accommodating member that accommodates each of the curved portions 33a and 33b of the optical fiber 33 in the information device 1 will be described with reference to FIGS. 7 and 8. FIGS. 7 and 8 are perspective views showing modifications of the accommodating member that accommodates each of the curved portions 33a and 33b of the optical fiber 33.

As shown in FIG. 7, an accommodating member 35A according to a first modification has a curved groove 35b corresponding to each of the curved portions 33a and 33b. The curved groove 35b is a groove bent similarly to the curved portion 33a or 33b, and may have a bending angle of, for example, 85 degrees to 95 degrees, and is bent at 90 degrees in one example. The accommodating member 35A can be attached to the corner 11b or 11c of the housing 11 of the first member 10. After attachment, the optical fiber 33 is fitted into the curved groove 35b of the accommodating member 35A. The accommodating member 35A may be attached to the housing 11 after fitting the optical fiber 33 into the curved groove 35b. Thereby, the curved portions 33a and 33b are formed. Note that portions corresponding to the curved portions 33a and 33b of the optical fiber 33 may be bent in advance, and each of the curved portions 33a and 33b may be fitted into the curved groove 35b. Even when this accommodating member 35A is used, the information device 1 including the curved portions 33a and 33b where the optical fiber 33 is bent at the corners 11b and 11c of the first member 10 can be obtained. When the curved portions 33a and 33b are formed by bending the optical fiber 33 in advance, the optical fiber 33 is bent at the curved portions 33a and 33b when no external force is applied to the optical fiber 33. This external force includes a force from the accommodating member 35A.

As shown in FIG. 8, an accommodating member 35B according to a second modification has a pair of claw portions corresponding to each of the curved portions 33a and 33b. The pair of claw portions of the accommodating member 35B are claw portions bent similarly to the curved portion 33a or 33b, and may have a bending angle of, for example, 85 degrees to 95 degrees, and may be bent at 90 degrees as an example. This accommodating member 35B is attached to each of the corners 11b and 11c of the housing 11 of the first member 10. Thereafter, the optical fiber 33 is fitted into the pair of claw portions of the accommodating member 35B. Thereby, the curved portions 33a and 33b are formed. The curved portions 33a and 33b of the optical fiber 33 each fitted into the accommodating member 35B may be those that have been bent in advance as described above, or may be those that have not been bent.

As described above, in the information device 1 according to the present embodiment, the optical fiber 33 optically connecting the first terminal 31 with the second terminal 32 is provided. In this case, signal transmission capacity can be increased in the information device 1. Further, in the information device 1, the optical fiber 33 is disposed in the first member 10 such that the optical fiber 33 has at least one curved portion 33a or 33b that is bent at the corner 11b or 11c of the first member 10 (housing 11). In this case, the optical fiber 33 can be disposed avoiding a region where a large member (for example, a display) is disposed in the first member 10, and damage to the optical fiber 33 can be prevented. Furthermore, in the information device 1, since the optical fiber 33 is used for signal transmission, noise to the signal can be reduced.

The information device 1 according to the present embodiment further includes the accommodating member 35, 35A or 35B that accommodates each of the curved portions 33a and 33b of the optical fiber 33. The accommodating member 35, 35A or 35B is attached to the corner 11b or 11c of the first member 10 (housing 11). In this case, the curved portion 33a or 33b of the optical fiber 33 is protected by the accommodating member 35, 35A or 35B. Therefore, damage to the optical fiber 33 can be further prevented.

In the information device 1 according to the present embodiment, the accommodating member 35 is integrally molded with the curved portion 33a or 33b of the optical fiber 33. In this case, movement of the optical fiber 33 with respect to the accommodating member 35 is restricted. Therefore, damage to the optical fiber 33 accompanying the movement can be prevented.

In the information device 1 according to the present embodiment, the accommodating member 35A has the curved groove 35b corresponding to each of the curved portions 33a and 33b of the optical fiber 33, and the curved portion 33a or 33b is fitted into the curved groove 35b. In this case, the curved portion 33a or 33b of the optical fiber 33 is securely fixed by the accommodating member 35A. Therefore, damage accompanying movement of the optical fiber 33 can be prevented.

In the information device 1 according to the present embodiment, the accommodating member 35 or 35A has the surface 35a parallel to the inner surface 11a of the housing 11. In this case, when attaching the accommodating member 35 or 35A to the first member 10, the accommodating member 35 or 35A can be attached with high accuracy by sucking the surface 35a using the suction jig 50. Therefore, the accommodating member 35 or 35A is not disposed with displacement to damage the optical fiber 33, and damage to the optical fiber 33 can be reduced.

In the information device 1 according to the present embodiment, each of the curved portions 33a and 33b may be a portion formed by bending the optical fiber 33 in advance. In other words, each of the curved portions 33a and 33b may be a portion where the optical fiber 33 is bent when no external force is applied to the optical fiber 33. In this case, when attaching the optical fiber 33 to the first member 10, damage at the curved portion 33a or 33b where the optical fiber 33 is bent can be prevented. In particular, when the curved portion 33a or 33b bent in advance is accommodated in the accommodating member 35, 35A or 35B, damage to the optical fiber 33 is more reliably prevented.

In the information device 1 according to the present embodiment, the optical fiber 33 may be bent at two or more locations in the first member 10, and the curved portions 33a and 33b include the curved portion 33a (first curved portion) bent at the corner 11b (first corner) of the first member 10 and the curved portion 33b (second curved portion) bent at another corner 11c (second corner) of the first member 10. In the curved portions 33a and 33b, the optical fiber 33 is bent to have an angle of 85 degrees to 95 degrees (for example, 90 degrees). In this case, the optical fiber 33 can be efficiently arranged along the frame of the first member 10 avoiding a region where a large member (for example, a display) is disposed. Therefore, the information device 1 can be reduced in size or thickness while preventing damage to the optical fiber 33.

In the information device 1 according to the present embodiment, each of the first terminal 31 and the second terminal 32 includes the board 31a, 32a, the electrical connector 31b, 32b disposed on the board 31a, 32a, and the photoelectric conversion element 31c, 32c electrically connected to the electrical connector 31b, 32b and optically connected to the optical fiber 33. In this case, photoelectric conversion can be performed in each of the first terminal 31 and the second terminal 32.

The information device 1 according to the present embodiment further includes the hinge 40 that connects the first member 10 with the second member 20 in an openable and closable manner. The optical fiber 33 is configured to pass through the hinge 40 between the first terminal 31 and the second terminal 32. Thereby, in the openable and closable information device 1, transmission capacity between the first member 10 and the second member 20 can be significantly increased while reducing the size or thickness of the device.

The information device and the manufacturing of the information device according to the present disclosure have been described above. However, the present disclosure is not limited to the above-described embodiments or various modifications. For example, in the above-described embodiment, a laptop computer has been described as an example of the information device, but the information device is not limited thereto. The information device according to the present disclosure may be, for example, another information device such as a server. Even in this case, the optical fiber 33 can be arranged in the same manner.

In the above-described embodiment, each of the curved portions 33a and 33b of the optical fiber 33 is accommodated in the accommodating member 35, 35A or 35B and disposed at the corner 11b or 11c of the housing 11. Each of the curved portions 33a and 33b of the optical fiber 33 may be bent to a predetermined angle by thermal processing or the like in advance, and such curved portions 33a and 33b may be directly attached and fixed to the housing 11. In this case, the accommodating member 35 or the like becomes unnecessary.

What is claimed is:

1. An information device comprising:
a first member including a first surface;
a second member connected to the first member;
a first terminal disposed in the first member;
a second terminal disposed in the second member; and
an optical fiber optically connecting the first terminal to the second terminal,
wherein the optical fiber is arranged along the first surface in the first member, and the optical fiber includes at least one curved portion that is bent at a corner of the first member.

2. The information device according to claim 1, further comprising:
an accommodating member that accommodates the curved portion of the optical fiber, the accommodating member being attached to the corner of the first member.

3. The information device according to claim 2,
wherein the accommodating member is integrally molded with the curved portion of the optical fiber.

4. The information device according to claim 2,
wherein the accommodating member includes a curved groove corresponding to the curved portion of the optical fiber, and the curved portion is fitted into the curved groove.

5. The information device according to claim 2,
wherein the accommodating member includes an attachment surface parallel to the first surface.

6. The information device according to claim 1,
wherein the curved portion is a portion where the optical fiber is bent when no external force is applied to the optical fiber.

7. The information device according to claim 1,
wherein the optical fiber is bent at two or more locations in the first member,
wherein the curved portion includes a first curved portion bent at a first corner of the first member and a second curved portion bent at a second corner of the first member, and
wherein in the first curved portion and the second curved portion, the optical fiber is bent to have an angle of 85 degrees to 95 degrees.

8. The information device according to claim 1,
wherein each of the first terminal and the second terminal comprises:
a board;
an electrical connector disposed on the board; and
a photoelectric conversion element electrically connected to the electrical connector and optically connected to the optical fiber.

9. The information device according to claim 1, further comprising:
a hinge that connects the first member with the second member in an openable and closable manner, wherein the optical fiber passes through the hinge between the first terminal and the second terminal.

10. A method for manufacturing an information device, comprising:
preparing an optical connection module including a first terminal, a second terminal, and an optical fiber optically connecting the first terminal to the second terminal;
preparing a device body including a first member including a first surface and a second member connected to the first member;
attaching the first terminal to the first member;
attaching the second terminal to the second member; and
arranging the optical fiber along the first surface in the first member,
wherein, when arranging the optical fiber, at least one curved portion where the optical fiber is bent at a corner of the first member is provided.

11. The method for manufacturing an information device according to claim 10,
wherein the optical connection module or the first member further includes an accommodating member configured to accommodate the curved portion of the optical fiber, and
wherein, when arranging the optical fiber, the accommodating member of the optical connection module in which the curved portion is accommodated is attached to the corner of the first member, or the optical fiber is attached to the accommodating member provided at the corner of the first member to form the curved portion.

12. The method for manufacturing an information device according to claim 11,
wherein the accommodating member includes an attachment surface facing the curved portion of the optical fiber, and
wherein, when attaching the accommodating member, the accommodating member is attached to the corner of the first member by sucking the attachment surface of the accommodating member using a suction jig.

13. The method for manufacturing an information device according to claim 11,
wherein, when arranging the optical fiber, the accommodating member accommodating the curved portion formed by bending the optical fiber in advance, is attached to the corner of the first member.

14. The method for manufacturing an information device according to claim 10,
wherein the first member further includes an accommodating member configured to accommodate the curved portion of the optical fiber, and
wherein, when arranging the optical fiber, the curved portion formed by bending the optical fiber in advance is attached to the accommodating member provided at the corner of the first member.

15. The method for manufacturing an information device according to claim 10,
wherein the first member and the second member are connected in an openable and closable manner by a hinge, and
wherein the optical fiber passes through the hinge between the first terminal and the second terminal.

16. An optical connection module comprising:
a first terminal;
a second terminal; and
an optical fiber optically connecting the first terminal to the second terminal,
wherein an accommodating member configured to accommodate a curved portion where the optical fiber is bent is provided, or a curved portion where the optical fiber is bent when no external force is applied to the optical fiber is formed in the optical fiber.
